(19) United States
(12) Patent Application Publication
(10) Pub. No.: US 2024/0332481 A1
(43) Pub. Date: Oct. 3, 2024

(54) Positive Electrode Current Collector Coated with Adhesion Enhancement Layer, Method for Manufacturing the Same and Positive Electrode for Lithium Secondary Battery And Lithium Secondary Battery Comprising The Same

(71) Applicant: LG Chem, Ltd., Seoul (KR)

(72) Inventors: Min-Soo Kim, Daejeon (KR); Jung-Hyun Seo, Daejeon (KR); Soon-Hwa Jung, Daejeon (KR)

(73) Assignee: LG Chem, Ltd., Seoul (KR)

(21) Appl. No.: 18/573,679

(22) PCT Filed: Oct. 24, 2022
(86) PCT No.: PCT/KR2022/016298

§ 371 Date: Dec. 22, 2023

(30) Foreign Application Priority Data
Nov. 3, 2021 (KR) 10-2021-0150120

(51) Int. Cl. H01M 4/04; H01M 4/02; H01M 4/131; H01M 4/1391; H01M 4/58; H01M 4/62; H01M 10/0525

(52) U.S. Cl. CPC H01M 4/0404; H01M 4/0471; H01M 4/131; H01M 4/1391; H01M 4/5825; H01M 4/623; H01M 10/0525; H01M 2004/028

(57) ABSTRACT

A method for manufacturing a positive electrode current collector coated with an adhesion enhancement layer includes: (S1) preparing an aqueous slurry in which a hydrocarbon-based water-soluble binder polymer is dissolved, and polyvinylidene fluoride-based polymer particles and a first conductive material are dispersed; and (S2) coating the aqueous slurry on at least one surface of a metal current collector and drying by thermal treatment at a higher temperature than a melting point of the polyvinylidene fluoride-based polymer particles to form the adhesion enhancement layer.

### CROSS-REFERENCE TO RELATED APPLICATIONS

The present application is a national phase entry under 35 U.S.C. § 371 of International Appl. No. PCT/KR2022/016298, filed on Oct. 24, 2022, which claims priority to Korean Patent Application No. 10-2021-0150120 filed on Nov. 3, 2021, the disclosures of which are incorporated herein by reference.

### TECHNICAL FIELD

The present disclosure relates to a method for manufacturing a positive electrode current collector coated with an adhesion enhancement layer, a positive electrode current collector coated with an adhesion enhancement layer manufactured therefrom, a method for manufacturing a positive electrode for a lithium secondary battery, a positive electrode for a lithium secondary battery manufactured therefrom and a lithium secondary battery comprising the same.

### BACKGROUND ART

Recently, with the rapid widespread use of electronic devices using batteries, for example, mobile phones, laptop computers and electric vehicles, there is a fast growing demand for secondary batteries with smaller size, lighter weight and higher capacity. In particular, lithium secondary batteries are gaining attention as a power source for driving mobile devices due to their light weight and high energy density advantages. Accordingly, there are many research and development efforts to improve the performance of lithium secondary batteries.

A lithium secondary battery comprises a positive electrode and a negative electrode made of active materials capable of intercalating and deintercalating lithium ions and an organic electrolyte solution or a polymer electrolyte solution filled between the positive electrode and the negative electrode, and produces electrical energy by oxidation and reduction reactions during the intercalation/deintercalation of lithium ions at the positive electrode and the negative electrode.

In general, the positive electrode of the lithium secondary battery is manufactured by coating a positive electrode active material slurry comprising a positive electrode active material, a conductive material, a binder polymer and a solvent on a positive electrode current collector made of a metal such as aluminum and drying to form a positive electrode active material layer. Specifically, the positive electrode is manufactured by weighing and mixing each constituent material of the positive electrode active material slurry, coating and drying the positive electrode active material slurry on the positive electrode current collector, and pressing.

The manufactured positive electrode is assembled into the lithium secondary battery through post-processing, and there is a likelihood that the positive electrode active material may be detached due to the low adhesion strength of the positive electrode active material layer and the current collector. This problem gets worse when the positive electrode active material is a lithium iron phosphate based positive electrode active material or the size of the active material is smaller.

To solve this problem, forming an adhesion enhancement layer comprising a binder polymer on the current collector before forming the positive electrode active material layer on the current collector has been proposed, but there is a need for the development of adhesion enhancement layers that can adhere the positive electrode active material layer to the current collector with high adhesion strength and have low interfacial resistance.

Meanwhile, there is a need for the manufacture of lithium secondary batteries that maintain the adhesion strength with electrodes when applied to lithium secondary batteries comprising electrolyte solutions.

### DISCLOSURE

### Technical Problem

An aspect of the present disclosure is directed to providing a positive electrode current collector coated with an adhesion enhancement layer that can improve the adhesion strength between a positive electrode active material layer and a current collector and has low interfacial resistance, a method for manufacturing the same, and a positive electrode for a lithium secondary battery and a secondary battery comprising the same.

Another aspect of the present disclosure is directed to providing a positive electrode current collector coated with an adhesion enhancement layer for maintaining the adhesion strength with electrodes when applied to lithium secondary batteries comprising electrolyte solutions, a method for manufacturing the same, and a positive electrode for a lithium secondary battery and a secondary battery comprising the same.

### Technical Solution

An aspect of the present disclosure provides a method for manufacturing a positive electrode current collector coated with an adhesion enhancement layer according to the following embodiment.

A first embodiment relates to the method for manufacturing a positive electrode current collector coated with an adhesion enhancement layer, comprising: (S1) preparing an aqueous slurry in which a hydrocarbon-based water-soluble binder polymer is dissolved and polyvinylidene fluoride-based polymer particles and a first conductive material are dispersed; and (S2) coating the aqueous slurry on at least one surface of a metal current collector and drying by thermal treatment at higher temperature than a melting point of the polyvinylidene fluoride-based polymer particles to form the positive electrode current collector coated with the adhesion enhancement layer.

A second embodiment relates to the method for manufacturing a positive electrode current collector coated with an adhesion enhancement layer according to the first embodiment, wherein the hydrocarbon-based water-soluble binder polymer is present in an amount of 5 to 50 parts by weight based on 100 parts by weight of the polyvinylidene fluoride-based polymer particles.

According to a third embodiment, in the first or second embodiment, the hydrocarbon-based water-soluble binder polymer may include at least one of hydrocarbon-based water-soluble polymers, for example, polyvinylalcohol, polyvinylpyrrolidone, maleic anhydride, tannic acid, poly acrylic acid and poly acrylamide.

A fourth embodiment relates to the method for manufacturing a positive electrode current collector coated with an adhesion enhancement layer according to the first to third embodiments, wherein the melting point of the polyvinylidene fluoride-based polymer particles is 50° C. to 150° C., more specifically 70° C. to 150° C., and most specifically 90° C. to 150° C.

A fifth embodiment relates to the method for manufacturing a positive electrode current collector coated with an adhesion enhancement layer according to the first to fourth embodiments, wherein the polyvinylidene fluoride-based polymer particles is a copolymer of vinylidene fluoride and hexafluoropropylene.

A sixth embodiment relates to the method for manufacturing a positive electrode current collector coated with an adhesion enhancement layer according to any one of the first to fifth embodiments, wherein a weight average molecular weight of the polyvinylidene fluoride-based polymer particles is 700,000 to 1,300,000, and more specifically 800,000 to 1,100,000.

A seventh embodiment relates to the method for manufacturing a positive electrode current collector coated with an adhesion enhancement layer according to any one of the first to sixth embodiments, wherein the thermal treatment is performed at a temperature that is 10° C. to 80° C. higher than the melting point of the polyvinylidene fluoride-based polymer particles.

An eighth embodiment provides a positive electrode current collector coated with an adhesion enhancement layer, comprising: a metal current collector; and the adhesion enhancement layer on at least one surface of the metal current collector, and comprising a hydrocarbon-based water-soluble binder polymer, a polyvinylidene fluoride-based polymer and a first conductive material, wherein the polyvinylidene fluoride-based polymer is distributed in island arrays over the at least one surface of the metal current collector.

A ninth embodiment relates to the positive electrode current collector coated with an adhesion enhancement layer according to the eighth embodiment, wherein the hydrocarbon-based water-soluble binder polymer is present in an amount of 5 to 50 parts by weight based on 100 parts by weight of the polyvinylidene fluoride-based polymer particles.

A tenth embodiment relates to the positive electrode current collector coated with an adhesion enhancement layer according to the eighth or ninth embodiment, wherein the hydrocarbon-based water-soluble binder polymer is at least one selected from the group consisting of polyvinylalcohol, polyvinylpyrrolidone, maleic anhydride, tannic acid poly acrylic acid and poly acrylamide.

An eleventh embodiment relates to the positive electrode current collector coated with an adhesion enhancement layer according to the eighth to tenth embodiments, wherein a melting point of the polyvinylidene fluoride-based polymer is 50° C. to 150° C., more specifically 70° C. to 150° C., and most specifically 90° C. to 150° C.

A twelfth embodiment provides a positive electrode for a lithium secondary battery comprising the positive electrode current collector coated with the adhesion enhancement layer according to any one of the eighth to eleventh embodiments; and a positive electrode active material layer disposed on the adhesion enhancement layer, and comprising a positive electrode active material, a second conductive material and a binder polymer.

A thirteenth embodiment relates to the positive electrode for a lithium secondary battery according to the twelfth embodiment, wherein the metal current collector consists of aluminum, and the positive electrode active material is represented by the following Formula 1:

<Formula 1>

Li₁₊ₐFe₁₋ₓMₓ(PO_{4-b})X_{b} where M is at least one selected from the group consisting of Al, Mg, Ni, Co, Mn, Ti, Ga, Cu, V, Nb, Zr, Ce, In, Zn and Y, and X is at least one selected from the group consisting of F, S and N, −0.5≤a≤+0.5, 0≤x≤0.5, 0≤b≤0.1)

A fourteenth embodiment relates to the positive electrode for a lithium secondary battery according to the twelfth or thirteenth embodiment, wherein the binder polymer included in the positive electrode active material layer is a polyvinylidene fluoride-based polymer.

A fifteenth embodiment provides a lithium secondary battery comprising the positive electrode according to the fourteenth embodiment; a negative electrode opposite the positive electrode; a separator between the positive electrode and the negative electrode; and an electrolyte.

### Advantageous Effects

According to an embodiment of the present disclosure, the polyvinylidene fluoride-based polymer is distributed in island arrays over the surface of the metal current collector and does not cover the entire surface of the current collector. Accordingly, the adhesion enhancement layer improves the adhesion strength between the positive electrode active material layer and the current collector and exhibits low interfacial resistance.

Additionally, the hydrocarbon-based water-soluble binder polymer included in the adhesion enhancement layer forms hydrogen bonds with the positive electrode active material layer, thereby improving the adhesion strength, and when an aluminum current collector is used, the hydrocarbon-based water-soluble binder polymer also forms hydrogen bonds with the oxidized aluminum current collector, thereby improving the adhesion strength. Additionally, when applied to lithium secondary batteries comprising electrolyte solutions, the adhesion enhancement layer has resistance to dissolution in the electrolyte solutions, thereby maintaining high adhesion strength with the positive electrode active material layer. This effect works better when the polyvinylidene fluoride-based polymer having a predetermined melting point range is used as the polyvinylidene fluoride-based polymer.

### DESCRIPTION OF DRAWINGS

The accompanying drawings illustrate an exemplary embodiment of the present disclosure, and together with the foregoing description of the present disclosure, serve to help a further understanding of the technical aspect of the present disclosure, so the present disclosure should not be construed as being limited to the drawings. Meanwhile, the shape, size, scale or proportion of the elements in the accompanying drawings may be exaggerated to emphasize a more clear description.

FIG. 1 is a scanning electron microscopy (SEM) image of an adhesion enhancement layer according to example 1.

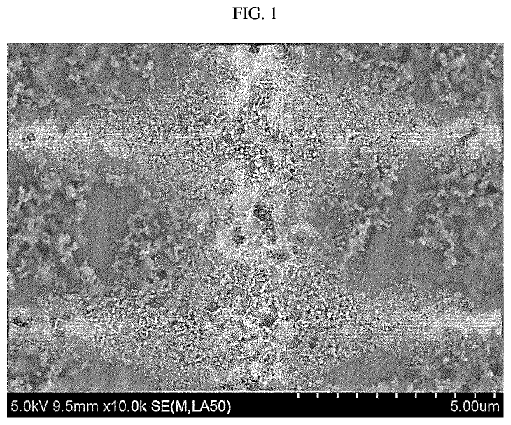

FIG. 2 a differential scanning calorimetry (DSC) chart of polymer A used in example 1.

### BEST MODE

Hereinafter, an embodiment of the present disclosure will be described in detail. Prior to the description, it should be understood that the terms or words used in the specification and the appended claims should not be construed as limited to general and dictionary meanings, but interpreted based on the meanings and concepts corresponding to technical aspects of the present disclosure, on the basis of the principle that the inventor is allowed to define terms appropriately for the best explanation. Therefore, the disclosure of the embodiments described herein is an exemplary embodiment of the present disclosure, but not intended to fully describe the technical aspect of the present disclosure, so it should be understood that a variety of other equivalents and modifications could have been made thereto at the time that the application was filed.

According to a method for manufacturing a positive electrode current collector coated with an adhesion enhancement layer according to an aspect of the present disclosure, an aqueous slurry is prepared in which a hydrocarbon-based water-soluble binder polymer is dissolved and polyvinylidene fluoride-based polymer particles and a first conductive material are dispersed.

The adhesion enhancement layer forming slurry is an aqueous slurry using water as a dispersion medium.

The aqueous slurry may further comprise selectively a solvent, for example, isopropylalcohol, acetone, ethanol and butyl alcohol to reduce the surface energy and improve the coating performance.

The aqueous slurry comprises the polyvinylidene fluoride-based polymer particles to improve the adhesion strength of the metal current collector and the positive electrode active material layer. The use of the particulate polyvinylidene fluoride-based polymer prevents an increase in resistance of the adhesion enhancement layer.

The melting point of the polyvinylidene fluoride-based polymer is preferably 50° C. to 150° C. When the polyvinylidene fluoride-based polymer has the above-described melting point range, the likelihood of dissolution in an electrolyte solution used in the battery assembly decreases, the adhesion strength with the electrode increases, and the drying temperature by thermal treatment of the aqueous slurry as describe below decreases, resulting in a reduction in energy consumption. In this view, more specifically, the melting point of the polyvinylidene fluoride-based polymer may be 70° C. to 150° C., more specifically 90° C. to 150° C., and most specifically 100° C. to 140° C. The polyvinylidene fluoride-based polymer may include, for example, a copolymer of vinylidene fluoride and hexafluoropropylene, but is not limited thereto.

The weight average molecular weight of the polyvinylfluoride-based polymer may be 700,000 to 1,300,000, and more specifically 800,000 to 1,100,000. When the weight average molecular weight is in the above-described range, the adhesion strength with the positive electrode active material layer is further enhanced.

Furthermore, in addition to the polyvinylfluoride-based polymer particles, it is obvious that the aqueous slurry may further comprise another binder polymer in particulate form without departing from the objective of the present disclosure.

Additionally, the aqueous slurry contains the hydrocarbon-based water-soluble binder polymer dissolved therein. The hydrocarbon-based water-soluble binder polymer may be dissolved by adding the hydrocarbon-based water-soluble binder polymer to water and heating, if necessary. The hydrocarbon-based water-soluble binder polymer forms hydrogen bonds with the positive electrode active material layer, thereby improving the adhesion strength, and when an aluminum current collector is used, the hydrocarbon-based water-soluble binder polymer also forms hydrogen bonds with the oxidized aluminum current collector, thereby improving the adhesion strength. Additionally, when applied to lithium secondary batteries comprising electrolyte solutions (non-aqueous electrolyte solutions), it has resistance to dissolution in the electrolyte solutions, thereby maintaining high adhesion strength with the positive electrode active material layer.

The hydrocarbon-based water-soluble binder polymer may be present in an amount of 5 to 50 parts by weight based on 100 parts by weight of the polyvinylidene fluoride-based polymer particles when considering degradation in the function and electrical performance of the hydrocarbon-based water-soluble binder polymer and the economical perspective. The hydrocarbon-based water-soluble binder polymer may include at least one hydrocarbon-based water-soluble polymer of polyvinylalcohol, polyvinylpyrrolidone, maleic anhydride, tannic acid, poly acrylic acid or poly acrylamide. These types of hydrocarbon-based water-soluble polymers have a good function of improving the adhesion strength.

Meanwhile, the aqueous slurry comprises the first conductive material to suppress the resistance rise in the positive electrode. The first conductive material may include, without limitation, any type of conductive material that has conductive properties without causing side reaction with the other elements of the battery, for example, graphite such as natural graphite or artificial graphite; carbon black such as carbon black (super-p), acetylene black, ketjen black, channel black, furnace black, lamp black, thermal black; conductive fibers such as carbon fibers or metal fibers; carbon nanotubes such as MW-CNT, SW-CNT; metal powder such as fluorocarbon, aluminum and nickel powder; conductive whiskers such as zinc oxide and potassium titanate; conductive metal oxide such as titanium oxide; or conductive materials such as polyphenylene derivatives, and they may be used singly or in combination to reduce the interfacial resistance.

A weight ratio of the fluoride-based polymer particles comprising the polyvinylidene fluoride-based polymer particles and the first conductive material in the aqueous slurry may be, for example, 0.5:1 to 8:1, but is not limited thereto. Additionally, the thickness of the adhesion enhancement layer on one surface of the metal current collector may be 50 to 5,000 nm.

The aqueous slurry may further comprise at least one type of thickening agent to control the viscosity. In particular, the thickening agent may include, but is not limited to, a polysaccharide-based cellulose thickening agent such as carboxymethylcellulose, hydroxymethylcellulose, ethylcellulose and methylcellulose, not a hydrocarbon-based water-soluble polymer.

In addition to the above-described components, the aqueous slurry may further comprise any other additive, for example, a dispersant without departing from the objective of the present disclosure.

Subsequently, the prepared aqueous slurry is coated on at least one surface of the metal current collector, and dried by thermal treatment at higher temperature than the melting point of the polyvinylidene fluoride-based polymer particles to form the adhesion enhancement layer (Step S2).

For the positive electrode current collector, the metal current collector such as aluminum is used. In particular, aluminum may be used in the form of a foil, and the aluminum foil easily oxidizes in air to form a surface layer of aluminum oxide. Accordingly, the current collector of aluminum should be interpreted as encompassing the current collector having the aluminum oxide surface layer formed by the oxidation of aluminum on the surface. The thickness of the metal current collector may be typically 3 to 500 μm, but is not limited thereto.

The common slurry coating methods and devices may be used to coat the aqueous slurry on the metal current collector, and the coating methods may include, for example, a bar coating method such as Meyer bar, a gravure coating method, a 2 roll reverse coating method, a vacuum slot die coating method and a 2 roll coating method. The adhesion enhancement layer is formed on at least one surface of the metal current collector, i.e., one or two surfaces of the metal current collector to improve the adhesion strength between the metal current collector and the positive electrode active material layer as described below. The thickness of the adhesion enhancement layer (the thickness of the adhesion enhancement layer formed on one surface of the metal current collector, not two surfaces) may be, for example, 50 to 5,000 nm, and more specifically 100 to 1,000 nm when considering the adhesion strength improvement effect and the extent of resistance rise in the positive electrode, but is not limited thereto.

The metal current collector coated with the aqueous slurry is dried by thermal treatment at higher temperature than the melting point of the polyvinylidene fluoride-based polymer particles to form the adhesion enhancement layer. Specifically, the drying process may be performed at higher temperature than the melting point of the polyvinylidene fluoride-based polymer particles by 10° C. to 80° C., but is not limited thereto.

When dried by thermal treatment at higher temperature than the melting point of polyvinylidene fluoride-based polymer particles, the polyvinylidene fluoride-based polymer particles melt, and as the temperature decreases during the drying process, they are solidified to form the adhesion enhancement layer bonded onto the metal current collector. In this instance, the polyvinylidene fluoride-based polymer of the adhesion enhancement layer is distributed in island arrays over the surface of the current collector. That is, the polyvinylidene fluoride-based polymer distributed in island arrays does not cover the entire surface of the current collector. Accordingly, the adhesion enhancement layer improves the adhesion strength between the positive electrode active material layer and the current collector and has low interfacial resistance.

Additionally, as the polyvinylidene fluoride-based polymer having the predetermined melting point range is preferably used as described above, it is possible to dry the aqueous slurry at relatively low temperature, thereby reducing energy consumption and the adhesion enhancement layer exhibits good adhesion performance. The adhesion enhancement layer has good resistance to dissolution in the electrolyte solution when applied to lithium secondary batteries comprising electrolyte solutions, thereby maintaining the adhesion strength with the positive electrode.

The positive electrode current collector coated with the adhesion enhancement layer, manufactured by the above-described manufacturing method according to an embodiment, comprises:
the metal current collector; and
the adhesion enhancement layer on at least one surface of the metal current collector, and comprising the hydrocarbon-based water-soluble binder polymer, the polyvinylidene fluoride-based polymer and the first conductive material,
wherein the polyvinylidene fluoride-based polymer is distributed in island arrays over the surface of the metal current collector.

The metal current collector and the binder and the conductive material of the adhesion enhancement layer in the positive electrode current collector coated with the adhesion enhancement layer have been described above, and their detailed description is omitted.

After the positive electrode current collector coated with the adhesion enhancement layer is manufactured by the above-described manufacturing method, the positive electrode active material layer comprising a positive electrode active material, a second conductive material and a binder polymer is stacked on and attached to the adhesion enhancement layer to manufacture a positive electrode for a lithium secondary battery. Accordingly, there is provided the positive electrode for a lithium secondary battery comprising the positive electrode current collector coated with the adhesion enhancement layer; and the positive electrode active material layer on the adhesion enhancement layer, and comprising the positive electrode active material, the second conductive material and the binder polymer.

The positive electrode active material may include the common positive electrode active materials used in lithium secondary batteries, for example, lithium transition metal oxide. In particular, the positive electrode active material may include positive electrode active materials represented by the following Formula 1.

<Formula 1>

Li₁₊ₐFe₁₋ₓMₓ(PO_{4-b})X_{b} (M is at least one selected from the group consisting of Al, Mg, Ni, Co, Mn, Ti, Ga, Cu, V, Nb, Zr, Ce, In, Zn and Y, and X is at least one selected from the group consisting of F, S and N, −0.5≤a≤+0.5, 0≤x≤0.5, 0≤b≤0.1)

The positive electrode active material of the above Formula 1 is a lithium iron phosphate-based compound, and has low adhesion strength especially with the aluminum current collector. Accordingly, there is a growing industrial need for the improved adhesion strength with the current collector by use of the adhesion enhancement layer according to the present disclosure.

The binder polymer used to bind the positive electrode active material may typically include binder polymers applied to positive electrode materials, for example, at least one of polyvinylidene fluoride (PVDF), polyvinylidene fluoride-co-hexafluoropropylene (PVDF-co-HFP), polyvinylalcohol, polyacrylonitrile, carboxymethylcellulose (CMC), starch, hydroxypropyl cellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or a variety of copolymers thereof. More preferably, the binder polymer included in the positive electrode active material may include a polyvinylidene fluoride-based polymer, and interaction with the polyvinylidene fluoride-based polymer of the adhesion enhancement layer increases the interlayer adhesion strength improvement effect.

The binder polymer included in the positive electrode active material layer may be included in an amount of 1 to 30 weight % based on the total weight of the positive electrode active material layer.

The second conductive material used in the positive electrode active material layer may be used independently of the first conductive material of the adhesion enhancement layer. The second conductive material may be typically included in an amount of 1 to 30 weight % based on the total weight of the positive electrode active material layer.

The method for stacking the positive electrode active material layer and attaching it to the adhesion enhancement layer may include the methods commonly used in the corresponding technical field.

For example, a positive electrode active material layer forming composition comprising the positive electrode active material, the second conductive material and the binder polymer may be coated on the adhesion enhancement layer, followed by drying and pressing.

In this instance, a solvent used in the positive electrode active material layer forming composition may include solvents commonly used in the corresponding technical field, for example, at least one of dimethyl sulfoxide (DMSO), isopropyl alcohol, N-methylpyrrolidone (NMP), acetone or water. The solvent may be used in such an amount so as to have sufficient viscosity to achieve good thickness uniformity when dissolving the binder polymer, dispersing the conductive material and the positive electrode active material, and subsequently, coating for manufacturing the positive electrode, in view of the coating thickness of the coating solution and the production yield.

The polyvinylidene fluoride-based polymer included in the adhesion enhancement layer has flowability when subjected to heat and pressure. For example, when subjected to heat and pressure at higher temperature than the glass transition temperature of the polyvinylidene fluoride-based polymer in the temperature range of the melting point (Tm) of the polymer−60° C. to the melting point (Tm) of the binder polymer+60° C., more specifically the temperature range of the melting point (Tm) of the binder polymer−50° C. to the melting point (Tm) of the binder polymer+50° C., and even more specifically the temperature range of the melting point (Tm) of the binder polymer−40° C. to the melting point (Tm) of the binder polymer+30° C., the binder polymer of the adhesion enhancement layer becomes flowable by the heat and attaches to the surface layer of the positive electrode active material layer in contact with the adhesion enhancement layer.

In the positive electrode for a lithium secondary battery according to an aspect, manufactured by the above-described manufacturing method, the thickness of the positive electrode active material layer (the thickness of the positive electrode active material layer on one surface of the adhesion enhancement layer, not two surfaces of the adhesion enhancement layer, after pressing) may be 40 to 200 μm, but is not limited thereto.

The adhesion strength of the positive electrode active material layer is preferably 50 gf/2 cm or more, and more preferably 60 gf/2 cm or more. Additionally, the interfacial resistance of the positive electrode active material layer is preferably 5 Ω/cm² or less.

Specifically, the lithium secondary battery comprises the positive electrode, a negative electrode opposite the positive electrode, a separator between the positive electrode and the negative electrode and an electrolyte, and the positive electrode is the same as described above. Additionally, optionally, the lithium secondary battery may further comprise a battery case accommodating an electrode assembly comprising the positive electrode, the negative electrode and the separator, and a sealing member to seal up the battery case.

In the lithium secondary battery, the negative electrode comprises a negative electrode current collector and a negative electrode active material layer on the negative electrode current collector.

The negative electrode current collector is not limited to a particular type and may include those having high conductivity without causing any chemical change to the battery, for example, copper, stainless steel, aluminum, nickel, titanium, sintered carbon, copper or stainless steel treated with carbon, nickel, titanium or silver on the surface and an aluminum-cadmium alloy, but is not limited thereto. Additionally, the negative electrode current collector may be typically 3 to 500 μm in thickness, and in the same way as the positive electrode current collector, the negative electrode current collector may have microtexture on the surface to improve the bonding strength with the negative electrode active material. For example, the negative electrode current collector may come in various forms, for example, films, sheets, foils, nets, porous bodies, foams and non-woven fabrics.

In addition to the negative electrode active material, the negative electrode active material layer optionally comprises a binder and a conductive material. For example, the negative electrode active material layer may be formed by coating a negative electrode forming composition comprising the negative electrode active material, and optionally the binder and the conductive material on the negative electrode current collector and drying, or by casting the negative electrode forming composition on a support, peeling off a film from the support and laminating the film on the negative electrode current collector.

The negative electrode active material may include compounds capable of reversibly intercalating and deintercalating lithium. Specific examples may include at least one of a carbonaceous material, for example, artificial graphite, natural graphite, graphitizing carbon fibers, amorphous carbon; a metallic compound that can form an alloy with lithium, for example, Si, Al, Sn, Pb, Zn, Bi, In, Mg, Ga, Cd, a Si alloy, a Sn alloy or an Al alloy; metal oxide capable of doping and undoping lithium such as SiOβ (0<β<2), SnO₂, vanadium oxide, lithium vanadium oxide; or a complex comprising the metallic compound and the carbonaceous material such as a Si—C complex or a Sn—C complex. Additionally, a metal lithium thin film may be used for the negative electrode active material. Additionally, the carbon material may include low crystalline carbon and high crystalline carbon. The low crystalline carbon typically includes soft carbon and hard carbon, and the high crystalline carbon typically includes high temperature sintered carbon, for example, amorphous, platy, flaky, spherical or fibrous natural graphite or artificial graphite, Kish graphite, pyrolytic carbon, mesophase pitch based carbon fibers, meso-carbon microbeads, mesophase pitches and petroleum or coal tar pitch derived cokes.

Additionally, the binder and the conductive material may be the same as those of the positive electrode described above.

On the other hand, in the lithium secondary battery, the separator separates the negative electrode from the positive electrode and provides a passage for movement of lithium ions, and may include, without limitation, any separator commonly used in lithium secondary batteries, and in particular, preferably, those having low resistance to the electrolyte ion movement and good electrolyte solution wettability. Specifically, the separator may include, for example, a porous polymer film made of a polyolefin-based polymer such as an ethylene homopolymer, a propylene homopolymer, an ethylene/butene copolymer, an ethylene/hexene copolymer and an ethylene/methacrylate copolymer or a stack structure of two or more porous polymer films. Additionally, the separator may include common porous non-woven fabrics, for example, non-woven fabrics made of high melting point glass fibers and polyethylene terephthalate fibers. Additionally, to ensure the heat resistance or mechanical strength, coated separators comprising ceramics or polymer materials may be used, and may be selectively used with a mono- or multi-layer structure.

Additionally, the electrolyte used in the present disclosure may include an organic liquid electrolyte, an inorganic liquid electrolyte, a solid polymer electrolyte, a gel polymer electrolyte, a solid inorganic electrolyte and a molten inorganic electrolyte, available in the manufacture of lithium secondary batteries, but is not limited thereto.

Specifically, the electrolyte may be an electrolyte solution comprising an organic solvent and a lithium salt.

The organic solvent may include, without limitation, any type of organic solvent that acts as a medium for the movement of ions involved in the electrochemical reaction of the battery. Specifically, the organic solvent may include an ester-based solvent, for example, methyl acetate, ethyl acetate, γ-butyrolactone, ε-caprolactone; an ether-based solvent, for example, dibutyl ether or tetrahydrofuran; a ketone-based solvent, for example, cyclohexanone; an aromatic hydrocarbon-based solvent, for example, benzene, fluorobenzene; a carbonate-based solvent, for example, dimethylcarbonate (DMC), diethylcarbonate (DEC), methylethylcarbonate (MEC), ethylmethylcarbonate (EMC), ethylene carbonate (EC), propylene carbonate (PC); an alcohol-based solvent, for example, ethylalcohol, isopropyl alcohol; nitriles of R—CN (R is a C2 to C20 straight-chain, branched-chain or cyclic hydrocarbon, and may comprise an exocyclic double bond or ether bond); amides, for example, dimethylformamide; dioxolanes, for example, 1,3-dioxolane; or sulfolanes. Among them, the carbonate-based solvent is desirable, and more preferably, the cyclic carbonate (for example, ethylene carbonate or propylene carbonate) having high ionic conductivity and high dielectric constant which contributes to the improved charge/discharge performance of the battery may be mixed with the linear carbonate-based compound (for example, ethylmethyl carbonate, dimethyl carbonate or diethyl carbonate) of low viscosity. In this case, the cyclic carbonate and the chain carbonate may be mixed at a volume ratio of about 1:1 to about 1:9 to improve the performance of the electrolyte solution.

The lithium salt may include, without limitation, any compound that can provide lithium ions used in lithium secondary batteries. Specifically, the lithium salt may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI or LiB(C₂O₄)₂. The concentration of the lithium salt may range from 0.1 to 2.0M. When the concentration of the lithium salt is included in the above-described range, the electrolyte has the optimal conductivity and viscosity, resulting in good performance of the electrolyte and effective movement of lithium ions.

In addition to the above-described constituent substances of the electrolyte, the electrolyte may further comprise, for example, at least one type of additive of a haloalkylene carbonate-based compound such as difluoro ethylene carbonate, pyridine, triethylphosphite, triethanolamine, cyclic ether, ethylene diamine, n-glyme, hexaphosphoric triamide, nitrobenzene derivatives, sulfur, a quinone imine dye, N-substituted oxazolidinone, N,N-substituted imidazolidine, ethylene glycol dialkyl ether, an ammonium salt, pyrrole, 2-methoxy ethanol or aluminum trichloride to improve the life characteristics of the battery, prevent the capacity fading of the battery and improve the discharge capacity of the battery. In this instance, the additive may be included in an amount of 0.1 to 5 weight % based on the total weight of the electrolyte.

The lithium secondary battery is useful in the field of mobile devices including mobile phones, laptop computers and digital cameras, and electric vehicles including hybrid electric vehicles (HEVs).

Accordingly, according to another embodiment of the present disclosure, there are provided a battery module comprising the lithium secondary battery as a unit cell and a battery pack comprising the same.

The battery module or the battery pack may be used as a power source of at least one medium- and large-scale device of power tools; electric vehicles including electric vehicles (EVs), hybrid electric vehicles, and plug-in hybrid electric vehicles (PHEVs); or energy storage systems.

Hereinafter, the embodiment of the present disclosure will be described in sufficiently detail for those having ordinary skill in the technical field pertaining to the present disclosure to easily practice the present disclosure. However, the present disclosure may be embodied in many different forms and is not limited to the disclosed embodiment.

### Example 1

Polymer A (Solvay, a copolymer of vinylidene fluoride and hexafluoropropylene, VDF:HFP=3:1 (weight ratio), the average particle size: 250 nm, the melting point: 100° C., Mw=1,080,000)] as fluoride-based polymer particles and denka carbon black (BET=60 m²/g, DBP-200 ml/100 g) were dispersed in water at a weight ratio of 2:1, and CMC (Daicel 2200, Mw 3,000,000) as a thickening agent for optimal viscosity was introduced at ⅕ weight of the PVDF binder polymer to prepare a dispersion solution. Polyvinylalcohol as a hydrocarbon-based water-soluble polymer was added to water at 1/10 weight of the fluoride-based polymer particles and dissolved for a day with the temperature rise to 80° C., to prepare 10% aqueous solution, which was added to the dispersion solution to prepare the final aqueous slurry with 10% solids.

Subsequently, the aqueous slurry was coated on two surfaces of a 20 μm thick aluminum foil using a Micro gravure coater and dried at 120° C. for 3 min to form an adhesion enhancement layer on the aluminum foil. A positive electrode active material slurry prepared by mixing LiFe(PO₄), polyvinylidene fluoride (Mw=630,000) as a binder polymer and denka carbon black (BET=60 m²/g, DBP-200 ml/100 g) as a conductive material at 96:2:2 was coated on the adhesion enhancement layer, dried at 140° C. for 10 min and pressed to manufacture a positive electrode.

A lithium metal was used for a negative electrode, and the negative electrode and the positive electrode were stacked with a separator (Celgard) interposed between the negative electrode and the positive electrode to manufacture an electrode assembly. The electrode assembly was punched into a coin shape, and an electrolyte solution in which 1M LiPF6 was dissolved in a mixed solvent (PC:EMC:EC=3:4:3) of propylene carbonate (PC), ethylmethyl carbonate (EMC) and ethylene carbonate (EC) was injected to manufacture a test lithium secondary battery.

### Examples 2-4

The same process as example 1 was performed except that changes were made as shown in the following Table 1.

### Comparative Example 1

The same process as example 1 was performed except that the solution of hydrocarbon-based water-soluble polymer in water was not added and changes were made as shown in the following Table 1.

### <Average Particle Size Measurement of Polymer Particles>

The polymer particles were scanned by SEM and the average particle size was measured by averaging the lengths of long axes of primary particles.

### <Average Particle Size Measurement of Conductive Material>

The average particle size D50 of the conductive material was measured using laser diffraction. The conductive material was dispersed in a dispersion medium and the average particle size D50 at 50% of the particle size distribution was calculated using a laser diffraction particle size measurement equipment (Microtac MT 3000).

### <Melting Point Measurement of Binder Polymer>

The melting point of the binder polymer was measured using differential scanning calorimetry (DSC).

5 to 10 mg of specimen was fed using TA DSC2500, and thermal scanning was performed with the increasing temperature at the heating rate of 10° C./min from 50 to 250° C. under a nitrogen atmosphere, the decreasing temperature at the cooling rate of 10° C./min, and the increasing temperature at the heating rate of 10° C./min from 50 to 250° C.

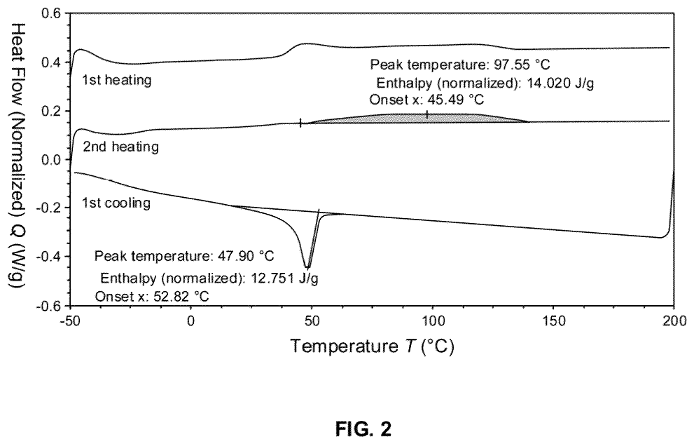

FIG. 2 is a DSC chart of the polymer A of example 1. Referring to FIG. 2, a melting point may be obtained by endothermic peaks during 2^{nd} heating, and the melting point is found to be the temperature at the peak apex.

### <Weight Average Molecular Weight Measurement of Polymer>

0.04 g of polymer was taken and dissolved in 10 g of tetrahydrofuran to prepare a sample specimen, and a reference specimen (polystyrene) and the sample specimen were filtered through a filter having the pore size of 0.45 μm, and injected into a GPC injector. The number average molecular weight, the weight average molecular weight and the polydispersity of the acrylic polymer were measured by comparing the elution time of the sample specimen with the calibration curve of the reference specimen. The measurements were made at the flow rate of 1.00 mL/min and the column temperature of 35.0° C. using GPC (Infinity II 1260, Agilent).

### <Adhesion Strength Evaluation>

The positive electrodes manufactured according to the examples and comparative examples were punched into a size of 2 cm (width)×10 cm (length) or more using a punching machine. Glass was used for a base plate (2.5 cm (width)×7.5 cm (length)×1T (thickness)), a 3M double-sided tape was attached to the glass, and the punched electrode was attached in parallel. The electrode attached to the tape was 6 cm, and the adhesion strength of the electrode was measured while maintaining 90° with the base plate using a texture analyzer (LLOYD).

### <WET Adhesion Strength Evaluation>

The WET adhesion strength evaluation was performed by storing the electrode coated foil through a vacuum drying oven at 130° C. for 24 hr to remove moisture, receiving the electrode in an aluminum pouch together with the electrolyte solution, sealing up the aluminum pouch, storing in the 70° C. oven for 2 weeks and measuring the adhesion strength. In this instance, to remove the remaining electrolyte solution, the electrode was washed using a DMC washing solution and completely dried, and measurements were made. As the adhesion enhancement layer was less resistant to dissolution than before the evaluation of the resistance to the electrolyte solution, the adhesion strength of the adhesion enhancement layer to the electrolyte solution was lower when applied to the lithium secondary battery.

### <Interfacial Resistance Evaluation>

The positive electrodes manufactured according to the examples and comparative examples were punched into a size of 5 cm (horizontal)×5 cm (vertical) using a punching machine. Each of the thickness of the punched electrode, the thickness of the aluminum foil and the specific resistance value (2.82E-06) of the current collector was input using Mp tester (HIOKI), and the punched electrode was placed below a tip at which a probe was embedded and measured by lowering the bar.

TABLE 1

| | | | | | | Comparative |
|---|---|---|---|---|---|---|
| | | Example 1 | Example 2 | Example 3 | Example 4 | example 1 |
| Adhesion | First binder | Polymer A | Polymer A | Polymer A | Polymer A | Polymer A |
| enhancement | Fluoride- | 2:1 | 2:1 | 2:1 | 2:1 | 2:1 |
| layer | based polymer | | | | | |
| | particles:first | | | | | |
| | conductive | | | | | |
| | material | | | | | |
| | (weight ratio) | | | | | |
| | Hydrocarbon- | Polyvinyl- | Polyvinyl- | Tannic | Maleic | Not |
| | based water- | alcohol | pyrrolidone | acid | anhydride | added |
| | soluble | | | | | |
| | polymer (1/10 | | | | | |
| | of fluoride- | | | | | |
| | based polymer | | | | | |
| | particles) | | | | | |
| | Thickness | 300 | 300 | 300 | 300 | 100 |
| | (nm, one | | | | | |
| | side/contact | | | | | |
| | type) | | | | | |
| | Drying | 120 | 120 | 120 | 120 | 120 |
| | temperature | | | | | |
| | (° C.) | | | | | |
| Positive | Thickness | 115 | 111 | 117 | 112 | 109 |
| electrode | (um, before | | | | | |
| active | pressing, one | | | | | |
| material | side) | | | | | |
| layer | Thickness | 91 | 91 | 92 | 88 | 91 |
| | (um, after | | | | | |
| | pressing, | | | | | |
| | one side) | | | | | |
| Results | Adhesion | 86 | 69 | 72 | 74 | 39 |
| | (gf/2 cm) | | | | | |
| | Interfacial | 0.9 | 0.8 | 1.1 | 1.3 | 0.5 |
| | resistance | | | | | |
| | (Ω/cm²) | | | | | |
| Durability | WET | 102 | 82 | 104 | 91 | 38 |
| evaluation | adhesion | | | | | |
| (Resistance | strength | | | | | |
| to | | | | | | |
| electrolyte | | | | | | |
| solution) | | | | | | |

1. A method for manufacturing a positive electrode current collector coated with an adhesion enhancement layer, comprising:
(S1) preparing an aqueous slurry in which a hydrocarbon-based water-soluble binder polymer is dissolved, polyvinylidene fluoride-based polymer particles and a first conductive material are dispersed; and
(S2) coating the aqueous slurry on at least one surface of a metal current collector and drying by thermal treatment at a higher temperature than a melting point of the polyvinylidene fluoride-based polymer particles to form the positive electrode current collector coated with the adhesion enhancement layer.

2. The method for manufacturing the positive electrode current collector coated with the adhesion enhancement layer according to claim 1, wherein the hydrocarbon-based water-soluble binder polymer is present in an amount of 5 to 50 parts by weight based on 100 parts by weight of the polyvinylidene fluoride-based polymer particles.

3. The method for manufacturing the positive electrode current collector coated with the adhesion enhancement layer according to claim 1, wherein the hydrocarbon-based water-soluble binder polymer is at least one selected from the group consisting of polyvinylalcohol, polyvinylpyrrolidone, maleic anhydride, tannic acid, poly acrylic acid and poly acrylamide.

4. The method for manufacturing the positive electrode current collector coated with the adhesion enhancement layer according to claim 1, wherein the melting point of the polyvinylidene fluoride-based polymer particles is from 50° C. to 150° C.

5. The method for manufacturing the positive electrode current collector coated with the adhesion enhancement layer according to claim 1, wherein the melting point of the polyvinylidene fluoride-based polymer particles is from 70° C. to 150° C.

6. The method for manufacturing the positive electrode current collector coated with the adhesion enhancement layer according to claim 1, wherein the polyvinylidene fluoride-based polymer particles are copolymers of vinylidene fluoride and hexafluoropropylene.

7. The method for manufacturing the positive electrode current collector coated with the adhesion enhancement layer according to claim 1, wherein a weight average molecular weight of the polyvinylidene fluoride-based polymer particles is from 700,000 to 1,300,000.

8. The method for manufacturing the positive electrode current collector coated with the adhesion enhancement layer according to claim 1, wherein a weight average molecular weight of the polyvinylidene fluoride-based polymer particles is from 800,000 to 1,100,000.

9. The method for manufacturing the positive electrode current collector coated with the adhesion enhancement layer according to claim 1, wherein the thermal treatment is performed at a temperature that is from 10° C. to 80° C. higher than the melting point of the polyvinylidene fluoride-based polymer particles.

10. A positive electrode current collector coated with an adhesion enhancement layer, comprising:
a metal current collector; and
the adhesion enhancement layer on at least one surface of the metal current collector, the adhesion enhancement layer comprising a hydrocarbon-based water-soluble binder polymer, a polyvinylidene fluoride-based polymer, and a first conductive material, wherein the polyvinylidene fluoride-based polymer is distributed in island arrays over the at least one surface of the metal current collector.

11. The positive electrode current collector coated with the adhesion enhancement layer according to claim 10, wherein the hydrocarbon-based water-soluble binder polymer is present in an amount of 5 to 50 parts by weight based on 100 parts by weight of the polyvinylidene fluoride-based polymer particles.

12. The positive electrode current collector coated with the adhesion enhancement layer according to claim 10, wherein the hydrocarbon-based water-soluble binder polymer is at least one selected from the group consisting of polyvinylalcohol, polyvinylpyrrolidone, maleic anhydride, tannic acid poly acrylic acid and poly acrylamide.

13. The positive electrode current collector coated with the adhesion enhancement layer according to claim 10, wherein the melting point of the polyvinylidene fluoride-based polymer is from 50° C. to 150° C.

14. A positive electrode for a lithium secondary battery, comprising:
the positive electrode current collector coated with the adhesion enhancement layer according to claim 10; and
a positive electrode active material layer disposed on the adhesion enhancement layer, the positive electrode active material layer comprising a positive electrode active material, a second conductive material, and a binder polymer.

15. The positive electrode for the lithium secondary battery according to claim 14, wherein the metal current collector is made of aluminum, and the positive electrode active material is represented by the following Formula 1:
<Formula 1>
Li₁₊ₐFe₁₋ₓMₓ(PO_{4-b})X_{b} wherein M is at least one selected from the group consisting of Al, Mg, Ni, Co, Mn, Ti, Ga, Cu, V, Nb, Zr, Ce, In, Zn and Y, X is at least one selected from the group consisting of F, S and N, −0.5≤a≤+0.5, 0≤x≤0.5, and 0≤b≤0.1.

16. The positive electrode for a lithium secondary battery according to claim 14, wherein the binder polymer of the positive electrode active material layer is a polyvinylidene fluoride-based polymer.

17. A lithium secondary battery comprising:
the positive electrode according to claim 14;
a negative electrode;
a separator between the positive electrode and the negative electrode; and
an electrolyte.
